(19) United States
(12) Patent Application Publication
(10) Pub. No.: US 2008/0314406 A1
(43) Pub. Date: Dec. 25, 2008

(54) METHODS AND APPARATUS FOR TEXTURED DENTAL FLOSS

(76) Inventor: Darwin N. Barrie, Chandler, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/141,293

(22) Filed: Jun. 18, 2008

Related U.S. Application Data
(60) Provisional application No. 60/944,725, filed on Jun. 18, 2007.

(51) Int. Cl. A61C 15/04

(52) U.S. Cl. 132/329; 132/200

(57) ABSTRACT

Methods and apparatus for textured dental floss according to various aspects of the present invention may operate in conjunction with a flexible substrate that may be placed in interdental spaces. In one embodiment, the flexible substrate may comprise at least one node affixed to the flexible substrate to assist in removal of plaque and particulate matter, to massage the gums and/or to deliver one or more additives.

### CROSS-REFERENCES TO RELATED APPLICATIONS

This application claims the benefit of U.S. Provisional Patent Application No. 60/944,725, filed Jun. 18, 2007, and incorporates the disclosure of such application by reference.

### BACKGROUND OF THE INVENTION

Dental plaque is a bacterial biofilm that may build up on the teeth of humans and/or other animals and cause damage to the teeth such as cavities and/or dental diseases such as periodontal disease. Prevention of these dental conditions may include dental hygiene practices such as tooth brushing and/or flossing. Brushing the teeth with toothpaste may fail to reach dental plaque and food particulates in the interdental spaces between teeth, which may contribute to the formation of dental plaque.

Flossing the interdental spaces between teeth is an important part of dental hygiene. Flossing may remove plaque and/or particulates such as food from between the teeth and/or below the gumline where a conventional toothbrush cannot reach. The frequent cleaning of interdental spaces may reduce the build up of the bacteria that may cause dental plaques, thus aiding in the prevention of cavities and gum diseases.

Flossing may include moving a filament of flexible material through interdental spaces between teeth. Conventional floss is generally planar and may be coated with wax for a smoother application into interdental spaces. The action of moving the floss may cause the floss to adhere to dental plaque and/or particulates by the friction of the floss on the teeth and gums. Conventional flossing techniques may include forming the floss into a C-shape around each side of a tooth and dipping the floss beneath the gumline. The floss may remove plaque and particulates as it scrapes the side of each tooth.

Flossing between the interdental spaces may fail to draw out particulates and dental plaque between wide interdental spaces. Conventional floss may also be laborious and time consuming in wider interdental spaces. For example, the floss may be worked around each tooth surface separately and may be imprecisely dragged over the gum surface of a wider interdental space, limiting the utility of floss for removing particulates. Further, the planar structure of conventional floss may merely glide over plaque deposits and/or lodged particulates, failing to remove them.

### SUMMARY OF THE INVENTION

Methods and apparatus for textured dental floss according to various aspects of the present invention may operate in conjunction with a flexible substrate that may be placed in interdental spaces. In one embodiment, the flexible substrate may comprise at least one node affixed to the flexible substrate to assist in removal of plaque and particulate matter, to massage the gums and/or to deliver one or more additives.

### BRIEF DESCRIPTION OF THE DRAWINGS

A more complete understanding of the present invention may be derived by referring to the detailed description and claims when considered in connection with the following illustrative figures, which may not be to scale. In the following figures, like reference numbers refer to similar elements and steps throughout the figures.

FIGS. 1 A-B representatively illustrate a dental article according to various aspects of the present invention;

FIGS. 2 A-B are a cross-sectional view of a dental article, according to various aspects of the present invention, inserted between an interdental space;

FIG. 3 is a front-view of a dental article, according to various aspects of the present invention, inserted between an interdental space in an animal's mouth; and

FIG. 4 is a flow diagram of a method of using a dental article according to various aspects of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of techniques, technologies, and methods configured to perform the specified functions and achieve the various results. For example, the present invention may employ various dental articles, dental floss, materials, medicines, flavorings, edible substrates, mouthwashes, cleaners, fresheners, and the like, which may carry out a variety of functions. In addition, the present invention may be practiced in conjunction with any number of devices, and the systems described are merely exemplary applications. Further, the present invention may employ any number of conventional techniques for promoting and/or maintaining dental hygiene, gum health, preventing tooth decay, freshening breath, and/or the like.

Various representative implementations of the present invention may be applied to any system for cleaning interdental spaces for dental hygiene. Certain representative implementations may include, for example, dental articles for traversing the interdental gaps between teeth and/or other systems for promoting dental health such as the prevention of cavities and gum disease. In one embodiment, methods and apparatus for cleaning interdental spaces according to various aspects of the present invention may operate in conjunction with a dental article to remove dental plaque and/or particulates such as food between the teeth of an animal such as a human.

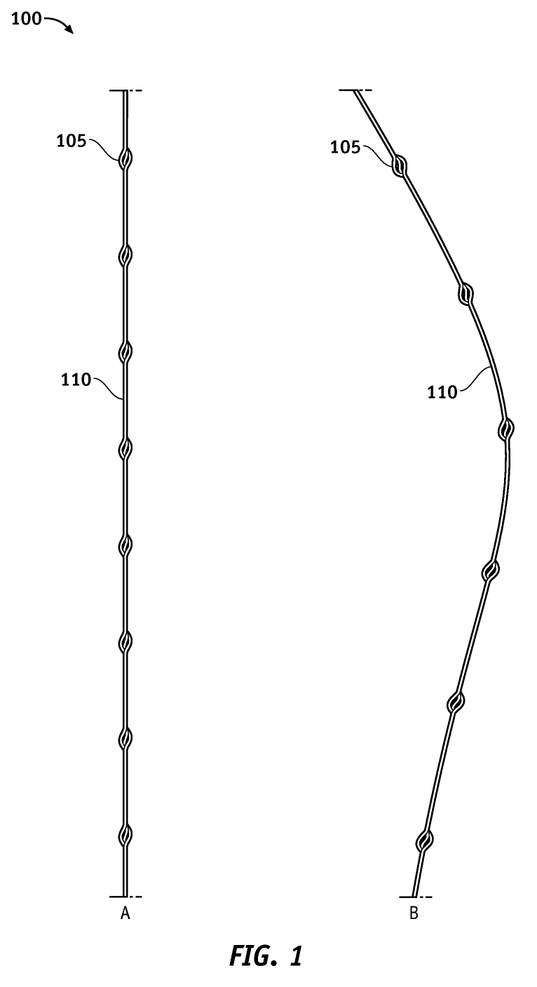

Referring now to FIGS. 1 A-B, the dental article 100 according to various aspects of the present invention may operate in conjunction with a flexible substrate 110 and one or more nodes 105. In one embodiment, the flexible substrate 110 may bend and/or twist by tactile manipulation and/or navigation around interdental spaces of various sizes and/or shapes (FIG. 1B).

The flexible substrate 110 may comprise any material suitable for application to interdental spaces between teeth, such as dental floss. For example, the flexible substrate 110 may comprise any conventional floss materials such as nylon, plastics such as Teflon and/or polyethylene, polytetrafluorethylene (PTFE), silk and/or other organic materials, inorganic materials and/or the like. The flexible substrate 110 may comprise multiple filament layers of material, such as nylon, for providing strength. Alternatively, the flexible substrate 110 may comprise a monofilament such as PTFE that may resist fraying during traversal of the interdental spaces. Further, the flexible substrate 110 may comprise woven filaments of conventional materials. The flexible substrate 110 may also comprise any size, shape such as planar and/or rounded, diameter, dimensions and/or thickness for insertion and/or movement through interdental spaces.

In one embodiment, the flexible substrate 110 may comprise a coating. For example, the flexible substrate 110 may be coated in a lubricant, Teflon, and/or a wax. For example, the flexible substrate 110 may be coated in a natural wax such as bees wax, Vege-wax, Soywax, and/or a synthetic wax such as a microcrystalline plastic white wax.

The coating may be applied to the flexible substrate 110 in any suitable manner to promote adherence. For example, the coating may be a powder, spray, solid, liquid, gel and/or the like. In one embodiment, the coating may be applied to the flexible substrate 110 by being sprayed, sprinkled, shaken and/or tossed onto the flexible substrate 110. In another embodiment, the flexible substrate 110 may be rolled, dipped, and/or drawn through the coating. Further, the coating may be applied to the flexible substrate 110 using a process comprising heating, baking, curing, bonding and/or the like.

The coating may assist in the insertion of the dental article 100 into interdental spaces. For example, the coating may provide a slick and/or slippery surface on flexible substrate 110, allowing the user to work the flexible substrate 110 into the interdental spaces without the application of excessive force that may cause an injury to the gums. In one embodiment, the coating may provide a smooth surface that may promote movement and/or oscillation through interdental spaces.

The coating may improve the strength and/or resistance of the flexible substrate 110 to fraying. For example, the coating may strengthen the flexible substrate 110 such that it may resist breakage upon the application of tension. The coating may also increase the ability of the flexible substrate 110 to resist fraying during use in the interdental spaces. For example, sharp edges of teeth, fillings, and/or other dental implementations may catch a portion of the flexible substrate 110, which may cause filaments of the flexible substrate 110 to separate. The coating may prevent the flexible substrate 110 from catching on teeth and/or dental implantations and may allow the flexible substrate 110 to resist fraying. In one embodiment, the coating may provide water resistance to the flexible substrate 110. In another embodiment, the coating may provide a sticky and/or tacky feel to the flexible substrate 110, increasing the ability of the flexible substrate 110 to bind dental plaque and/or particulates for efficient removal.

The coating may comprise an antimicrobial substance such as bactericides and anti-viral substances. For example, antimicrobial substances such as baking soda, sodium fluoride, calcium peroxide and/or the like may be applied to the flexible substrate 110. Alternatively, the antimicrobial substances may be incorporated into the coating for application to the flexible substrate 110. In one embodiment, the antimicrobial substances may be released and/or deposited into the interdental space by the mechanical forces encountered while flossing. In another embodiment, the antimicrobial substances may be released through enzymatic processes in the mouth.

The flexible substrate 110 according to various aspects of the present invention, may comprise a flavor such as mint, peppermint, bubblegum, and/or fruit flavors, such as cranberry, strawberry, banana and/or the like. For example, the flavor of the flexible substrate 110 may provide a pleasant taste. Additionally, flavors such as mint may enhance and/or freshen the breath and/or clean teeth. The flavor may comprise a powder, spray, solid, liquid, gel, syrup and/or the like. In one embodiment, the flavor may be added to the flexible substrate 110 independently and/or through the addition of the flavor to the coating and the subsequent application of the coating to the flexible substrate 110. The flavor may be added to the flexible substrate 110 by any conventional methods such as dipping, rolling, spraying, sprinkling and/or the like. Further, the flavor may be applied to the flexible substrate 110 using a process comprising heating, baking, curing, bonding and/or the like.

The dental article 100 according to various aspects of the present invention may comprise at least one node 105 affixed to the flexible substrate 110. The node 105 may comprise any suitable system for providing a protruding and/or textured structure for assisting in dental hygiene. The node 105 may also comprise any shape suitable for assistance in removing plaque, and/or particulates, massaging the gums, and/or delivering substances orally. For example, the node 105 may comprise various two dimensional and/or three dimensional shapes and/or partial shapes, such as bubbles, knots, and twists in the flexible substrate 110 as well as amorphous nodes, blocks, cubes, ripples, spheres, ovoids, prolate and/or oblate spheroids, and/or the like. In one embodiment, the bubble may comprise at least one dimension that is larger than the width of the flexible substrate 110. In another embodiment, the bubble may comprise at least one dimension that is substantially equal or smaller than the width of the flexible substrate 110.

The node 105 may be affixed to the flexible substrate 110 in any suitable manner. For example, the protruding and/or textured structure of the node 105 may comprise a shape such as a bubble that may be pressed into the flexible substrate 110. In the present embodiment, the node 105 comprises a structure that may be larger in at least one dimension than the flexible substrate 110. The node 105 may comprise an enlarged structure that is substantially rigid. Alternatively, the node 105 may comprise an enlarged structure that is substantially flexible such that the node 105 may flatten and/or deform when tension is placed on the flexible substrate 110 and/or the node 105 is moved through an interdental space that is narrower than the node 105.

The node 105 may comprise an alteration of the flexible substrate 110 filament(s) itself. In the present embodiment, the node 105, according to various aspects of the present invention, may comprise a bubble shape pressed into the flexible substrate 110. The bubble shape may be pressed into the flexible substrate 110 using a node press comprising any conventional manufacturing techniques such as machinery, presses, hand manipulated tools and/or the like. In one embodiment, the node press may comprise any press with one or more gears and/or spokes that, when applied to one side of the flexible substrate 110, leaves an indentation on the pressed side of the flexible substrate and/or a bulge on the other side of the flexible substrate 110. In another embodiment, the node press may displace and/or compress a portion of the flexible substrate 110 by applying pressure, forming a bubble at the node 105.

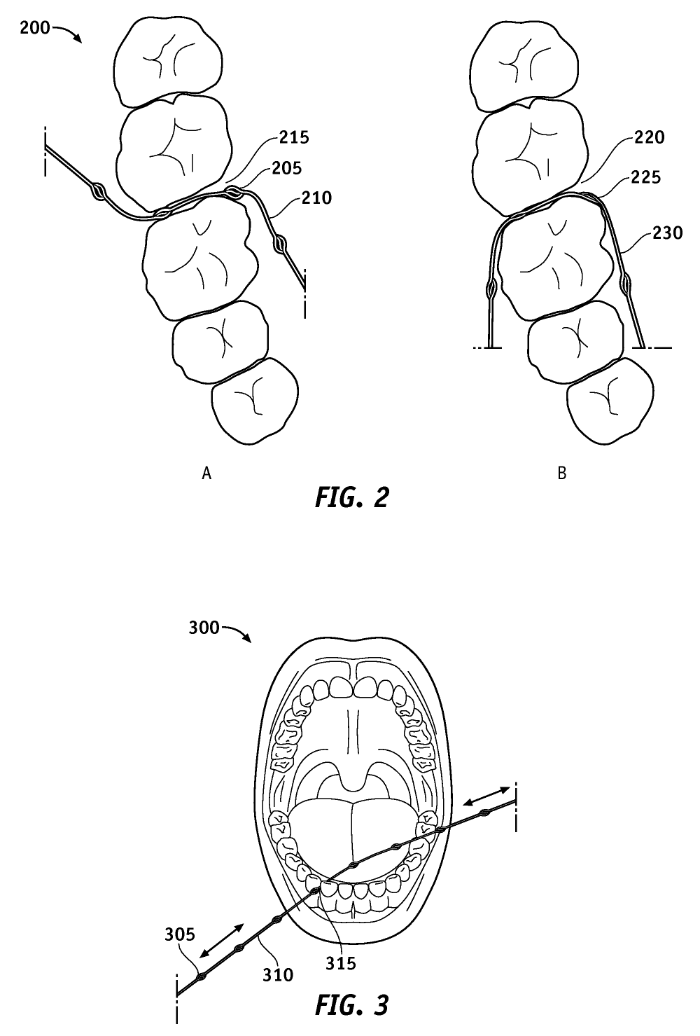

Referring to FIG. 2, a node 205, according to various aspects of the present invention, may comprise a bubble shape that may be at least one of flexible and/or malleable. In one embodiment, the node 205 may retain the bubble shape while a flexible substrate 210 is applied and/or pulled through a wide interdental space 215. Alternatively, a node 225 may be stretched flat by the application of sufficient tension to a flexible substrate 230. The node 225 may also be stretched flat while traversing a narrow interdental space 220. Accordingly, the dental article 100 may operate in both wide and narrow interdental spaces.

In one embodiment, referring now to FIG. 3, there may be a plurality of nodes 305 placed along a flexible substrate 310. For example, the nodes 305 may be placed in a predicted sequence such as ¼-1 inch intervals along the length of the flexible substrate 310. Alternatively, the nodes 305 may be placed along the length of the flexible substrate 310 in a random pattern.

Alternatively and/or conjunctively, the node 105 may comprise a carrier particle that may be configured to rupture, break and/or release an additive during application. For example, the node may comprise any suitable biocompatible carrier particle, wherein the particle may be configured to disintegrate, rupture and/or release the carried additive or additives. In this embodiment, the node may be configured as a delivery particle for any suitable additive.

The additive may comprise any suitable compound for delivery to the mouth of an animal. For example, the additive may comprise an antibacterial substance, an antiviral substance and/or a medicine. Further, the additive may comprise a fluoride, a flavor, a cleaning substance such as a toothpaste, baking soda, a detergent, and a breath freshening substance such as a mint and/or a disinfectant.

The node 105 according to various aspects of the present invention may further comprise a separately added structure that may be applied to and/or disposed within the flexible substrate 110. For example, the node 105 may comprise a bead that may be inserted and/or attached during and/or after manufacturing of the flexible substrate 110. Further, the node may comprise a removable structure so that it may be removed before, during or after application. The removable node 105 may be attached to the flexible substrate 110 such as by an adhesive substance, bonding such as by heated processes, a clamp, a clip, an opening in the removable structure for the attachment of the flexible substrate 110 and/or the like.

In one embodiment, the node 105 may comprise a brush. The brush may comprise any suitable structure configured for attachment and/or disposal within the flexible substrate 110. For example, the brush may comprise a small plastic hub attached to the flexible substrate 110 such as by adhesive. In one embodiment, the small plastic hub may be approximately 1/16 inches in length. Small flexible tines and/or bristles may protrude from the small plastic hub. The small flexible tines and/or bristles may comprise plastic, synthetic fibers such as nylon, and/or natural fibers such as animal hair. The small flexible tines and/or bristles may operate to massage the gums, remove dental plaque, and remove particulates and/or the like.

The dental article 100 according to various aspects of the present invention may operate in conjunction with add-on flossing devices. For example, the dental article 100 of the present invention may be applied to any conventional flossing devices, such as handheld tools, wands, frames, containers, dispensers, spools, trays, and/or the like. The add-on flossing devices may comprise any suitable size, shape, form, texture, dimensions and integrity and/or the like.

The dental article 100 of the present invention may be vibrated through the use of add-on dental vibration devices. In one embodiment, the dental article 100 may be applied, inserted, and/or operated in conjunction with vibration devices that may comprise a mechanical and/or electrical dental tool for flossing the teeth.

Alternatively and/or conjunctively, the dental article 100 may be illuminated by add-on optical devices, such as a light and/or or a glow-in-the-dark material. For example, in one embodiment, the dental article 100 may be illuminated by any system for providing increased visibility and/or light. Luminescent, phosphorescent, and/or florescent substances such as powdered pigments and/or the like may be applied to the dental article 100 to provide increased visibility.

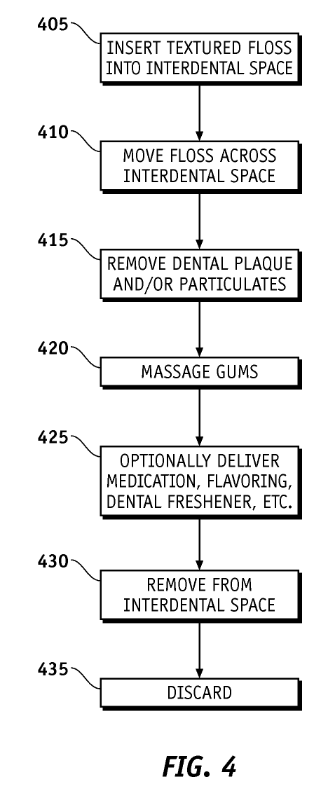

In operation, referring now to FIG. 4, the dental article 100 according to various aspects of the present invention may be implemented to manage interdental spaces, such as by cleaning of the spaces. In one embodiment, the dental article 100 may be configured to remove plaque and/or particulates between and/or around the interdental spaces. In another embodiment, the dental article 100 may also comprise any suitable system for delivering medicinal, dental cleaning, dental freshening and/or edible substances. In yet another embodiment, the dental article 100 may comprise any suitable system for massaging the gums.

The dental article 100 may comprise any system for removing plaque and/or particulates from the interdental space 215. In the present embodiment, the dental article 100 may be inserted into the interdental space 215 (405). The dental article 100 may be moved across the interdental space 215 such that the node 10s may interact and/or contact dental plaque and/or particulates (410). Upon contact, the node 105 may stick, capture, and/or push particulates and/or at least part of a plaque out of interdental space 215 (415).

The node 105 of the dental article 100 may massage the gums as the flexible substrate 110 is applied and/or pulled through the interdental space 215 (420). The massaging and/or rubbing action across and/or under the gums may aid in the removal and/or disruption of populations of disease causing microbes from the gumline of an animal's mouth 300. Disruption and/or removal of microbes such as bacteria that cause tooth decay may result in reduced gum related diseases such as gingivitis and/or periodontal disease.

Optionally, the node 105 may comprise a medication, a dental cleaning substance, a dental freshener, an edible substance and/or the like (425). For example, the node 105 may comprise a small portion of toothpaste, a mint, a mouthwash, and/or a medicine for oral delivery. In one embodiment, the node 105 may comprise a flavor such as a natural and/or an artificial fruit flavor and/or sweetener that may induce people to floss their teeth.

The dental article 100 may be removed from the interdental space 215 upon completion of cleaning (430). The dental article 100 may also be discarded subsequently to removal from the interdental spaces 215 (435), and/or recycled for further use.

The particular implementations shown and described are illustrative of the invention and its best mode and are not intended to otherwise limit the scope of the present invention in any way. Indeed, for the sake of brevity, conventional dental hygiene tools, materials, techniques, and other functional aspects of the system (and components of the individual operating components of the systems) may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same. Likewise, the examples provided in the present description are merely examples, and the inclusion of such examples should not be regarded as limiting the scope of the disclosure. Instead, elements and systems illustrated by such examples should be construed, unless otherwise indicated, as including such possible implementations without being limited to any such possibilities.

1. A dental article, comprising:
a flexible substrate comprising at least one node affixed to the flexible substrate, wherein the flexible substrate and the node are configured for placement in an interdental space.

2. The dental article of claim 1, wherein the flexible substrate is configured to at least one of: clean at least one of a tooth and a gum, remove at least one of a plaque and a particulate, massage a gum, and deliver an additive.

3. The dental article of claim 1, further comprising a plurality of nodes that are at least one of evenly and unevenly spaced in the flexible substrate.

4. The dental article of claim 3, wherein the plurality of nodes affixed to the flexible substrate are evenly spaced approximately ¼-1 inch apart.

5. The dental article of claim 1, wherein the node comprises at least one of: a twisted portion of the flexible substrate, a bubble in the flexible substrate, a knot in the flexible substrate, a removable structure and a brush.

6. The dental article of claim 1, wherein the flexible substrate further comprises a coating, wherein the coating comprises at least one of: a lubricant, Teflon, a wax, a flavor, an antimicrobial substance, baking soda, sodium fluoride and calcium peroxide.

7. The dental article of claim 1, wherein at least one of the flexible substrate and the node further comprise at least one additive, wherein the additive comprises at least one of: an antibacterial substance, an antiviral substance, a medicine, fluoride, a flavor, a cleaning substance, and a breath freshening substance.

8. The dental article of claim 7, wherein the node further comprising at least one additive is configured to release the additive in response to contact with at least one of a tooth and a gum.

9. A dental floss, comprising:
a flexible substrate configured for placement in an interdental space, and
at least one node comprising a protruding structure pressed into the flexible substrate, wherein the node is configured for placement in the interdental space.

10. The dental floss of claim 9, wherein the flexible substrate is configured to at least one of: clean at least one of a tooth and a gum; remove at least one of a plaque and a particulate, massage a gum, and deliver an additive.

11. The dental floss of claim 9, further comprising a plurality of nodes that are at least one of evenly and unevenly spaced in the flexible substrate.

12. The dental floss of claim 11, wherein the plurality of nodes are evenly spaced approximately ¼-1 inch apart.

13. The dental floss of claim 9, wherein the node comprises at least one of: a twisted portion of the flexible substrate, a bubble in the flexible substrate, a knot in the flexible substrate, a removable structure and a brush.

14. The dental floss of claim 9, wherein the flexible substrate further comprises a coating, wherein the coating comprises at least one of: a lubricant, Teflon, a wax, a flavor, an antimicrobial substance, baking soda, sodium fluoride and calcium peroxide.

15. The dental floss of claim 9, wherein at least one of the flexible substrate and the node further comprise at least one additive, wherein the additive comprises at least one of: an antibacterial substance, an antiviral substance, a medicine, fluoride, a flavor, a cleaning substance, and a breath freshening substance.

16. The dental floss of claim 15, wherein the node further comprising at least one additive is configured to release the additive in response to contact with at least one of a tooth and a gum.

17. A method of cleaning at least one of a tooth and gum, comprising:
disposing a flexible substrate comprising at least one node in an interdental space, and
moving the flexible substrate and the node through the interdental space.

18. The method of claim 17, wherein the flexible substrate is configured to at least one of: clean at least one of a tooth and a gum, remove at least one of a plaque and a particulate, massage a gum, and deliver an additive.

19. The method of claim 17, further comprising a plurality of nodes that are at least one of evenly and unevenly spaced in the flexible substrate.

20. The method of claim 19, wherein the plurality of nodes are evenly spaced approximately ¼-1 inch apart.

21. The method of claim 17, wherein the node comprises at least one of: a twisted portion of the flexible substrate, a bubble in the flexible substrate, a knot in the flexible substrate, a removable structure and a brush.

22. The method of claim 17, wherein the flexible substrate is incorporated into a dental tool.

23. The method of claim 22, wherein the dental tool comprises a wand for applying tension to the flexible substrate.

24. The method of claim 17, wherein the flexible substrate further comprises a coating, wherein the coating comprises at least one of: a lubricant, Teflon, a wax, a flavor, an antimicrobial substance, baking soda, sodium fluoride and calcium peroxide.

25. The method of claim 17, wherein at least one of the flexible substrate and the node further comprise at least one additive, wherein the additive comprises at least one of: an antibacterial substance, an antiviral substance, a medicine, fluoride, a flavor, a cleaning substance, and a breath freshening substance.

26. The method of claim 25, wherein the node further comprising at least one additive is configured to release the additive in response to contact with at least one of the tooth and the gum.
